(19) United States
(12) Patent Application Publication
(10) Pub. No.: US 2018/0359950 A1
(43) Pub. Date: Dec. 20, 2018

(54) SYSTEMS AND METHODS FOR RECYCLING HEAT IN A GROW POD

(71) Applicant: Grow Solutions Tech LLC, Lehi, UT (US)

(72) Inventors: Gary Bret Millar, Highland, UT (US); Mark Gerald Stott, Eagle Mountain, UT (US); Michael Stephen Hurst, Farmington, UT (US)

(73) Assignee: Grow Solutions Tech LLC, Lehi, UT (US)

(21) Appl. No.: 15/991,307

(22) Filed: May 29, 2018

Related U.S. Application Data
(60) Provisional application No. 62/519,628, filed on Jun. 14, 2017.
(60) Provisional application No. 62/519,624, filed on Jun. 14, 2017.
(60) Provisional application No. 62/519,304, filed on Jun. 14, 2017.

(51) Int. Cl. A01G 9/24; A01G 9/20; A01G 7/04

(52) U.S. Cl. CPC A01G 9/246; A01G 7/045; A01G 9/20

(57) ABSTRACT

A heat recycling system is provided. The system includes a shell including an enclosed area, an air supplier within the enclosed area, one or more vents connected to the air supplier and configured to output air within the enclosed area, a heat generating device within the enclosed area, a heat insulating element configured to cover the heat generating device and connected to a heat passageway, a heat transfer device connected to the heat passageway, and a controller. The controller determines a target temperature for the enclosed area, determines whether a temperature within the enclosed area is greater than the target temperature, and controls the heat transfer device to transfer the air heated by the heat generating device to an outside of the shell in response to determination that the temperature within the enclosed area is greater than the target temperature.

### CROSS REFERENCE TO RELATED APPLICATIONS

This application claims the benefit of U.S. Provisional Patent Application Nos. 62/519,624, 62/519,628 and 62/519,304 all filed on Jun. 14, 2017, the entire contents of which are herein incorporated by reference.

### TECHNICAL FIELD

Embodiments described herein generally relate to systems and methods for recycling heat in a grow pod and, more specifically, to recycling heat from heat generating devices in a grow pod.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the United States currently has suitable farmland to adequately provide food for the U.S. population, other countries and future populations may not have enough farmland to provide the appropriate amount of food.

While some current solutions provide greenhouses or other indoor crop growth systems, these indoor crop growth systems often include devices such as lighting devices and transformers that generate heat which may affect plants growing in the system. Thus, a system for managing heat generated in an indoor crop grow pod may be needed.

### SUMMARY

In one embodiment, a heat recycling system is provided. The system includes a shell including an enclosed area, an air supplier within the enclosed area, one or more vents connected to the air supplier and configured to output air within the enclosed area, a heat generating device within the enclosed area, a heat insulating element configured to cover the heat generating device and connected to a heat passageway, a heat transfer device connected to the heat passageway, and a controller. The controller determines a target temperature for the enclosed area, determines whether a temperature within the enclosed area is greater than the target temperature, and controls the heat transfer device to transfer the air heated by the heat generating device to an outside of the shell in response to determination that the temperature within the enclosed area is greater than the target temperature.

In another embodiment, a method for recycling heat in an assembly line grow pod includes determining, by a controller of the assembly line grow pod, a target temperature for an area enclosed by a shell, determining, by the controller of the assembly line grow pod, whether a temperature within the area is greater than the target temperature, and controlling, by the controller of the assembly line grow pod, a heat transfer device to transfer air heated by a heat generating device within the area to an outside of the shell in response to determination that the temperature within the area is greater than the target temperature.

In another embodiment, a heat recycling system includes a shell including an enclosed area, the shell including an outer wall and an inner wall, an air supplier within the enclosed area, one or more vents connected to the air supplier and configured to output air within the enclosed area, a heat generating device within the enclosed area, a heat insulating element configured to cover the heat generating device and connected to a heat passageway, a heat transfer device connected to the heat passageway, and a controller. The controller includes one or more processors, one or more memory modules, and machine readable instructions stored in the one or more memory modules that, when executed by the one or more processors, cause the controller to: determine a target temperature within the enclosed area, determine whether a temperature within the enclosed area is greater than the target temperature, and control the heat transfer device to transfer the air heated by the heat generating device to an area between the inner wall and the outer wall in response to determination that the temperature within the enclosed area is greater than the target temperature.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an assembly line grow pod, according to embodiments described herein;

FIG. 2 depicts an external shell enclosing the assembly line grow pod in FIG. 1, according to embodiments described herein;

FIG. 3A depicts an industrial cart for coupling to a track, according to embodiments described herein;

FIG. 3B depicts a plurality of industrial carts in an assembly line configuration, according to embodiments described herein;

FIG. 3C depicts an assembly grow pod including a HVAC system configured to control temperature for the assembly line grow pod, according to embodiments described herein;

FIG. 4 depicts recycling heat from heat generating devices, according to one or more embodiments shown and described herein;

FIG. 5 depicts recycling heat from heat generating devices, according to another embodiment shown and described herein;

FIG. 6 depicts a flowchart for recycling heat in an assembly line grow pod, according to embodiments shown and described herein;

FIG. 7 depicts a flowchart for recycling heat in an assembly line grow pod, according to another embodiments shown and described herein; and

FIG. 8 depicts a computing device for an assembly line grow pod, according to embodiments described herein.

### DETAILED DESCRIPTION

Embodiments disclosed herein include systems and methods for recycling heat. A system includes a shell including an enclosed area, an air supplier within the enclosed area, one or more vents connected to the air supplier and configured to output air within the enclosed area, a heat generating device within the enclosed area, a heat insulating element configured to cover the heat generating device and transfer heated air by the heat generating device to a heat passageway, a heat transfer device connected to the heat passageway, and a controller. The controller determines a target temperature for the enclosed area; determines whether a temperature within the enclosed area is greater than the target temperature; and controls the heat transfer device to transfer the heated air to an outside of the shell in response to determination that the temperature within the enclosed area is greater than the target temperature. The system for recycling heat in a grow pod incorporating the same will be described in more detail, below.

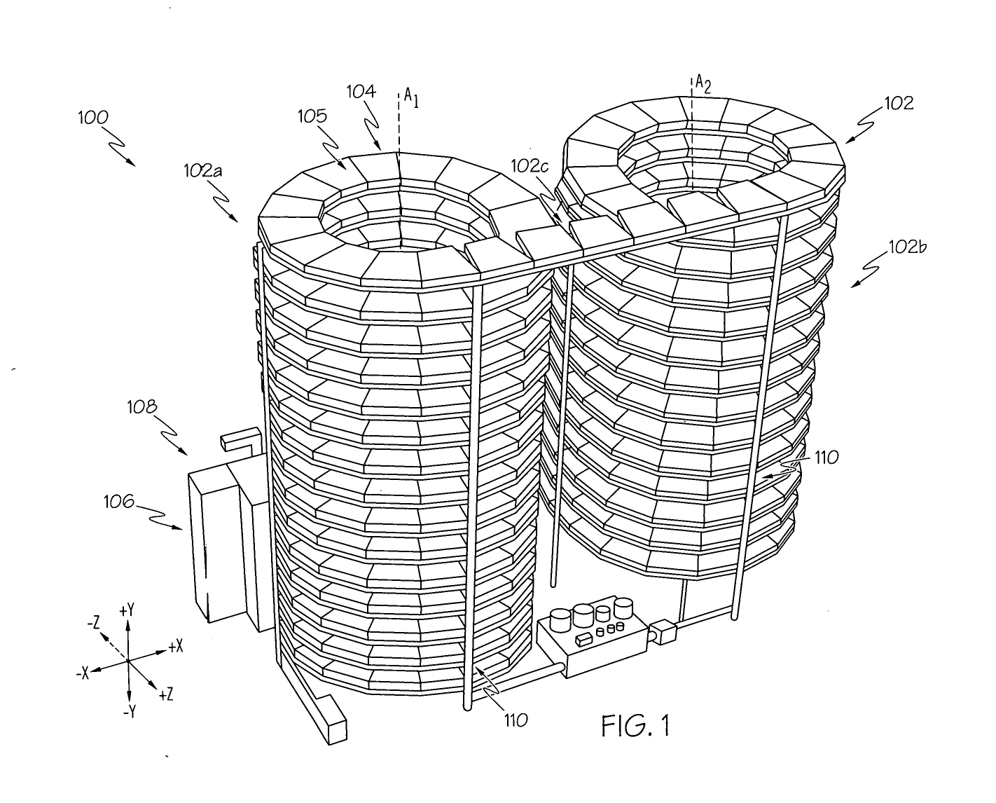

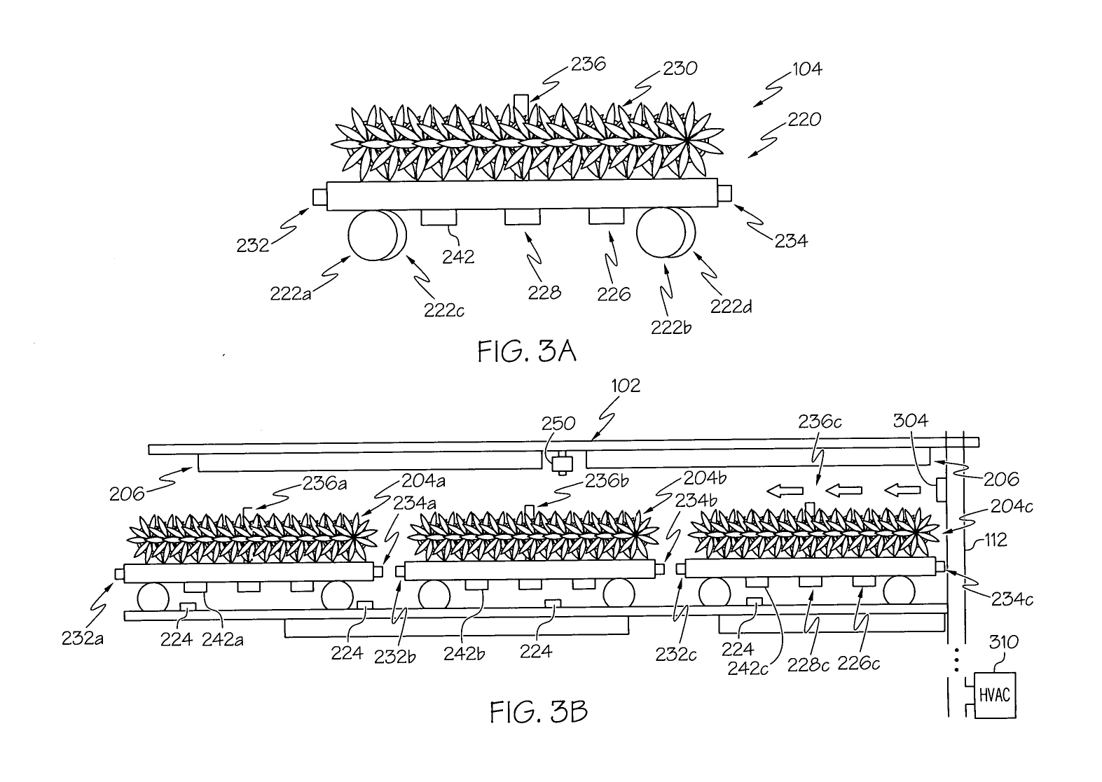

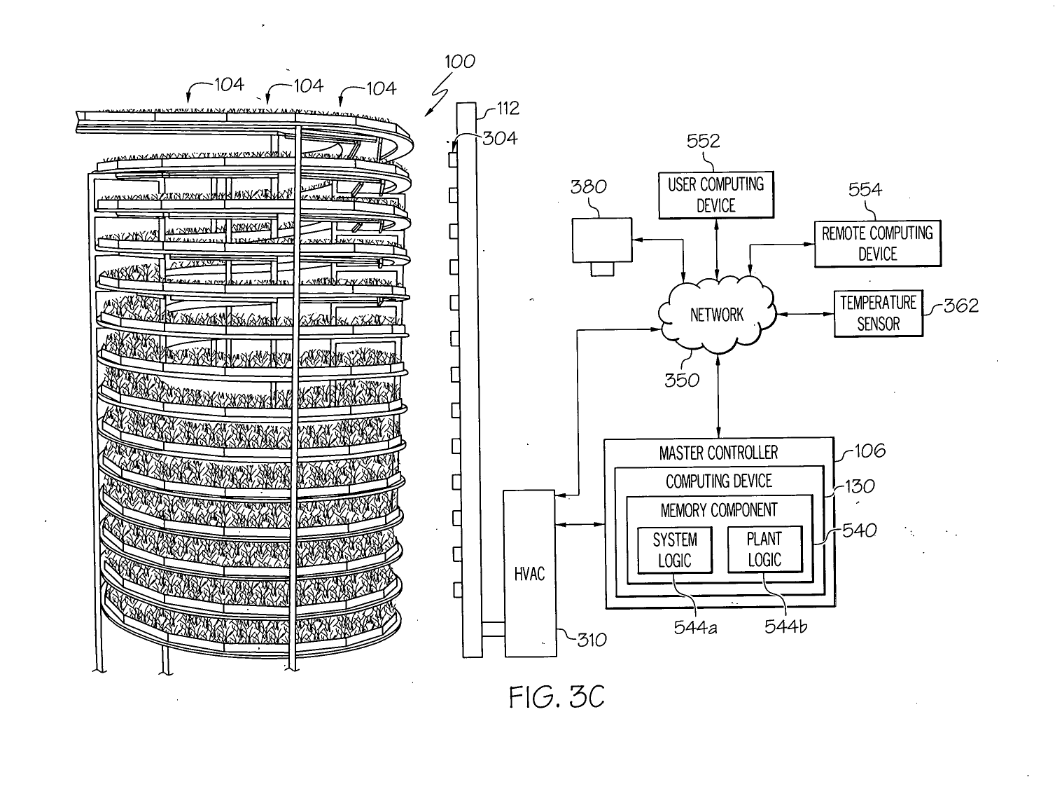

Referring now to the drawings, FIG. 1 depicts an assembly line grow pod 100 that receives a plurality of industrial carts 104, according to embodiments described herein. The assembly line grow pod 100 may be positioned on an x-y plane as shown in FIG. 1. As illustrated, the assembly line grow pod 100 may include a track 102 that holds one or more industrial carts 104. Each of the one or more industrial carts 104, as described in more detail with reference to FIGS. 3A and 3B, may include one or more wheels 222a, 222b, 222c, and 222d rotatably coupled to the industrial cart 104 and supported on the track 102, as described in more detail with reference to FIGS. 3A and 3B.

Additionally, a drive motor is coupled to the industrial cart 104. In some embodiments, the drive motor may be coupled to at least one of the one or more wheels 222a, 222b, 222c, and 222d such that the industrial cart 104 may be propelled along the track 102 in response to a signal transmitted to the drive motor. In other embodiments, the drive motor may be rotatably coupled to the track 102. For example, without limitation, the drive motor may be rotatably coupled to the track 102 through one or more gears which engage a plurality of teeth arranged along the track 102 such that the industrial cart 104 may be propelled along the track 102.

The track 102 may consist of a plurality of modular track sections. The plurality of modular track sections may include a plurality of straight modular track sections and a plurality of curved modular track sections. The track 102 may include an ascending portion 102a, a descending portion 102b, and a connection portion 102c. The ascending portion 102a and the descending portion 102b may include the plurality of curved modular track sections. The ascending portion 102a may wrap around (e.g., in a counterclockwise direction as depicted in FIG. 1) a first axis such that the industrial carts 104 ascend upward in a vertical direction. The first axis may be parallel to the z-axis as shown in FIG. 1 (i.e., perpendicular to the x-y plane).

The descending portion 102b may be wrapped around a second axis (e.g., in a counterclockwise direction as depicted in FIG. 1) that is substantially parallel to the first axis, such that the industrial carts 104 may be returned closer to ground level. The plurality of curved modular track sections of the descending portion 102b may be tilted relative to the x-y plane (i.e., the ground) by a predetermined angle.

The connection portion 102c may include a plurality of straight modular track sections. The connection portion 102c may be relatively level with respect to the x-y plane (although this is not a requirement) and is utilized to transfer the industrial carts 104 from the ascending portion 102a to the descending portion 102b. In some embodiments, a second connection portion (not shown in FIG. 1) may be positioned near ground level that couples the descending portion 102b to the ascending portion 102a such that the industrial carts 104 may be transferred from the descending portion 102b to the ascending portion 102a. The second connection portion may include a plurality of straight modular track sections.

In some embodiments, the track 102 may include two or more substantially parallel rails that support the industrial cart 104 via the one or more wheels 222a, 222b, 222c, and 222d rotatably coupled thereto. In some embodiments, at least two of the substantially parallel rails of the track 102 are electrically conductive, thus capable of transmitting communication signals and/or power to and from the industrial cart 104. In yet other embodiments, a portion of the track 102 is electrically conductive and a portion of the one or more wheels 222a, 222b, 222c, and 222d are in electrical contact with the portion of the track 102 which is electrically conductive. In some embodiments, the track 102 may be segmented into more than one electrical circuit. That is, the electrically conductive portion of the track 102 may be segmented with a non-conductive section such that a first electrically conductive portion of the track 102 is electrically isolated from a second electrically conductive portion of the track 102 which is adjacent to the first electrically conductive portion of the track 102.

The communication signals and power may further be received and/or transmitted via the one or more wheels 222a, 222b, 222c, and 222d of the industrial cart 104 and to and from various components of industrial cart 104, as described in more detail herein. Various components of the industrial cart 104, as described in more detail herein, may include the drive motor, the control device, and one or more sensors.

In some embodiments, the communication signals and power signals may include an encoded address specific to an industrial cart 104 and each industrial cart 104 may include a unique address such that multiple communication signals and power may be transmitted over the same track 102 and received and/or executed by their intended recipient. For example, the assembly line grow pod 100 system may implement a digital command control system (DCC). DDC systems encode a digital packet having a command and an address of an intended recipient, for example, in the form of a pulse width modulated signal that is transmitted along with power to the track 102.

In such a system, each industrial cart 104 includes a decoder, which may be the control device coupled to the industrial cart 104, designated with a unique address. When the decoder receives a digital packet corresponding to its unique address, the decoder executes the embedded command. In some embodiments, the industrial cart 104 may also include an encoder, which may be the control device coupled to the industrial cart 104, for generating and transmitting communications signals from the industrial cart 104, thereby enabling the industrial cart 104 to communicate with other industrial carts 104 positioned along the track 102 and/or other systems or computing devices communicatively coupled with the track 102.

While the implementation of a DCC system is disclosed herein as an example of providing communication signals along with power to a designated recipient along a common interface (e.g., the track 102) any system and method capable of transmitting communication signals along with power to and from a specified recipient may be implemented. For example, in some embodiments, digital data may be transmitted over AC circuits by utilizing a zero-cross, step, and/or other communication protocol.

Additionally, while not explicitly illustrated in FIG. 1, the assembly line grow pod 100 may also include a harvesting component, a tray washing component, and other systems and components coupled to and/or in-line with the track 102. In some embodiments, the assembly line grow pod 100 may include a plurality of lighting devices, such as light emitting diodes (LEDs). The lighting devices may be disposed on the track 102 opposite the industrial carts 104, such that the lighting devices direct light waves to the industrial carts 104 on the portion the track 102 directly below. In some embodiments, the lighting devices are configured to create a plurality of different colors and/or wavelengths of light, depending on the application, the type of plant being grown, and/or other factors. Each of the plurality of lighting devices may include a unique address such that a master controller 106 may communicate with each of the plurality of lighting devices. While in some embodiments, LEDs are utilized for this purpose, this is not a requirement. Any lighting device that produces low heat and provides the desired functionality may be utilized.

Also depicted in FIG. 1 is a master controller 106. The master controller 106 may include a computing device 130, a nutrient dosing component, a water distribution component, and/or other hardware for controlling various components of the assembly line grow pod 100. In some embodiments, the master controller 106 and/or the computing device 130 are communicatively coupled to a network 350 (as depicted and further described with reference to FIG. 3C). The master controller 106 may control operations of the HVAC system 310 shown in FIG. 3C, which will be described in detail below.

Coupled to the master controller 106 is a seeder component 108. The seeder component 108 may be configured to seed one or more industrial carts 104 as the industrial carts 104 pass the seeder in the assembly line. Depending on the particular embodiment, each industrial cart 104 may include a single section tray for receiving a plurality of seeds. Some embodiments may include a multiple section tray for receiving individual seeds in each section (or cell). In the embodiments with a single section tray, the seeder component 108 may detect presence of the respective industrial cart 104 and may begin laying seed across an area of the single section tray. The seed may be laid out according to a desired depth of seed, a desired number of seeds, a desired surface area of seeds, and/or according to other criteria. In some embodiments, the seeds may be pre-treated with nutrients and/or anti-buoyancy agents (such as water) as these embodiments may not utilize soil to grow the seeds and thus might need to be submerged.

In the embodiments where a multiple section tray is utilized with one or more of the industrial carts 104, the seeder component 108 may be configured to individually insert seeds into one or more of the sections of the tray. Again, the seeds may be distributed on the tray (or into individual cells) according to a desired number of seeds, a desired area the seeds should cover, a desired depth of seeds, etc. In some embodiments, the seeder component 108 may communicate the identification of the seeds being distributed to the master controller 106.

The watering component may be coupled to one or more water lines 110, which distribute water and/or nutrients to one or more trays at predetermined areas of the assembly line grow pod 100. In some embodiments, seeds may be sprayed to reduce buoyancy and then flooded. Additionally, water usage and consumption may be monitored, such that at subsequent watering stations, this data may be utilized to determine an amount of water to apply to a seed at that time.

Also depicted in FIG. 1 are airflow lines 112. Specifically, the master controller 106 may include and/or be coupled to one or more components that delivers airflow for temperature control, humidity control, pressure control, carbon dioxide control, oxygen control, nitrogen control, etc. Accordingly, the airflow lines 112 may distribute the airflow at predetermined areas in the assembly line grow pod 100. For example, the airflow lines 112 may extend to each story of the ascending portion 102a and the descending portion 102b.

It should be understood that while some embodiments of the track may be configured for use with a grow pod, such as that depicted in FIG. 1, this is merely an example. The track and track communications are not so limited and can be utilized for any track system where communication is desired.

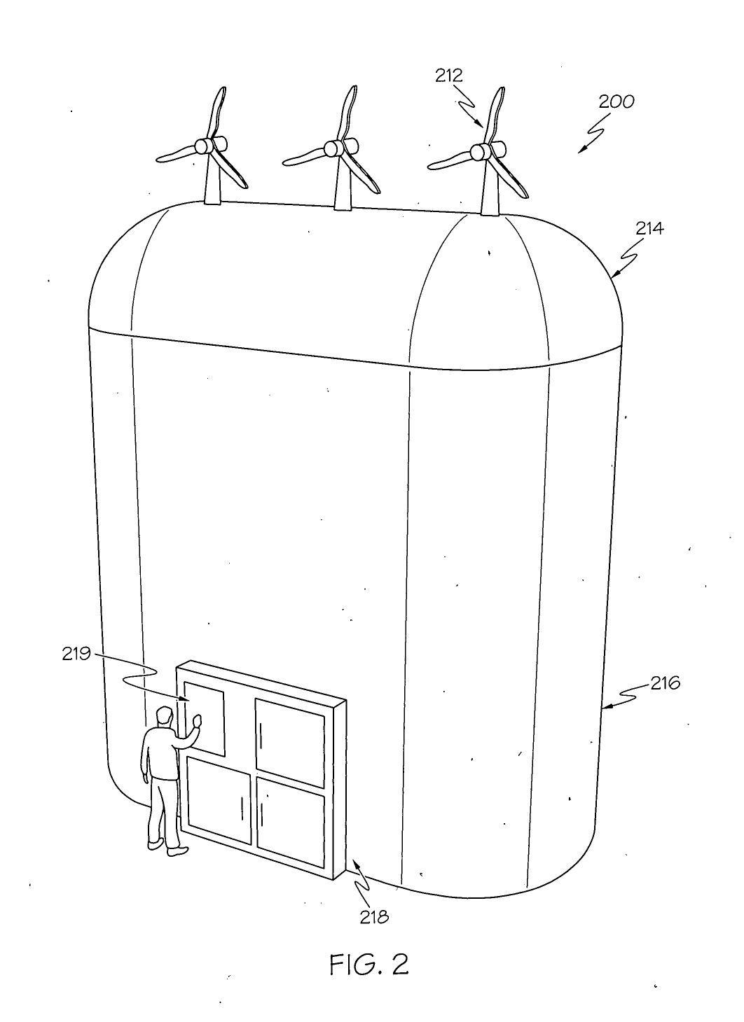

Referring now to FIG. 2 depicts an external shell 200 of the assembly line grow pod 100 of FIG. 1 according to embodiments described herein. As illustrated, the external shell 200 contains the assembly line grow pod 100 inside, maintains an environment inside, and prevents the external environment from entering. The external shell 200 includes a roof portion 214 and a side wall portion 216. In some embodiments, the roof portion 214 may include photoelectric cells that may generate electric power by receiving sunlight. In some embodiments, the roof portion 214 may include one or more wind turbines 212 that may generate electric power using wind. Coupled to the external shell 200 is a control panel 218 with a user input/output device 219, such as a touch screen, monitor, keyboard, mouse, etc.

The air inside the external shell 200 may be maintained independent of the air outside of the external shell 200. For example, the temperature of the air inside the external shell 200 may be different from the temperature of the air outside the external shell 200. The temperature of the air inside the external shell 200 may be controlled by the HVAC system 310 shown in FIG. 3C. The external shell 200 may be made of insulating material that prevents heat from transferring between outside and inside of the external shell 200. Airflow outside the external shell 200 does not affect the airflow inside the external shell 200. For example, the wind speed of the air inside the external shell 200 may be different from the wind speed of the air outside the external shell 200. The air inside the external shell 200 may include nitrogen, oxygen, carbon dioxide, and other gases, the proportions of which are similar to the proportions of the air outside the external shell 200. In some embodiments, the proportions of nitrogen, oxygen, carbon dioxide, and other gases inside the external shell 200 may be different from the proportions of the air outside the external shell 200. The dimensions of the air inside the external shell 200 may be less than, 10,000 cubic feet, for example, about 4,000 cubic feet.

FIG. 3A depicts an industrial cart 104 that may be utilized for the assembly line grow pod 100, according to embodiments described herein. As illustrated, the industrial cart 104 includes a tray section 220 and one or more wheels 222a, 222b, 222c, and 222d. The one or more wheels 222a, 222b, 222c, and 222d may be configured to couple with the track 102, as well as receive power, from the track 102. The track 102 may additionally be configured to facilitate communication with the industrial cart 104 through the one or more wheels 222a, 222b, 222c, and 222d.

In some embodiments, one or more components may be coupled to the tray section 220. For example, a drive motor 226, a cart computing device 228, and/or a payload 230 may be coupled to the tray section 220 of the industrial cart 104. The tray section 220 may additionally include a payload 230. Depending on the particular embodiment, the payload 230 may be configured as plants (such as in an assembly line grow pod 100); however this is not a requirement, as any payload 230 may be utilized.

The drive motor 226 may be configured as an electric motor and/or any device capable of propelling the industrial cart 104 along the track 102. For example, without limitation, the drive motor 226 may be configured as a stepper motor, an alternating current (AC) or direct current (DC) brushless motor, a DC brushed motor, or the like. In, some embodiments, the drive motor 226 may comprise electronic circuitry which may adjust the operation of the drive motor 226 in response to a communication signal (e.g., a command or control signal) transmitted to and received by the drive motor 226. The drive motor 226 may be coupled to the tray section 220 of the industrial cart 104 or directly coupled to the industrial cart 104.

In some embodiments, the cart computing device 228 may control the drive motor 226 in response to a leading sensor 232, a trailing sensor 234, and/or an orthogonal sensor 242 included on the industrial cart 104. Each of the leading sensor 232, the trailing sensor 234, and the orthogonal sensor 242 may comprise an infrared sensor, visual light sensor, an ultrasonic sensor, a pressure sensor, a proximity sensor, a motion sensor, a contact sensor, an image sensor, an inductive sensor (e.g., a magnetometer) or other type of sensor. The industrial cart 104 may include a temperature sensor 236.

In some embodiments, the leading sensor 232, the trailing sensor 234, the temperature sensor 236, and/or the orthogonal sensor 242 may be communicatively coupled to the master controller 106 (FIG. 1). In some embodiments, for example, the leading sensor 232, the trailing sensor 234, the temperature sensor 236, and the orthogonal sensor 242 may generate one or more signals that may be transmitted via the one or more wheels 222a, 222b, 222c, and 222d and the track 102 (FIG. 1). In some embodiments, the track 102 and/or the industrial cart 104 may be communicatively coupled to a network 350 (FIG. 3C). Therefore, the one or more signals may be transmitted to the master controller 106 via the network 350 over network interface hardware 634 (FIG. 8) or the track 102 and in response, the master controller 106 may return a control signal to the drive motor 226 for controlling the operation of one or more drive motors 226 of one or more industrial carts 104 positioned on the track 102. In some embodiments, the master controller 106 may control the operation of the HVAC system 310 to adjust air flow from the vent 304 shown in FIG. 3B. For example, the master controller 106 receives temperature detected by the temperature sensor 236 and controls the operation of the HVAC system 310 to adjust temperature of the air from the vent 304.

While FIG. 3A depicts the temperature sensor 236 positioned generally above the industrial cart 104, as previously stated, the temperature sensor 236 may be coupled with the industrial cart 104 in any location which allows the temperature sensor 236 to detect the temperature above and/or below the industrial cart 104. In some embodiments, the temperature sensor 236 may be positioned on the track 102 or other components of the assembly line grow pod 100.

In some embodiments, location markers 224 may be placed along the track 102 or the supporting structures to the track 102 at pre-defined intervals. The orthogonal sensor 242, for example, without limitation, comprises a photo-eye type sensor and may be coupled to the industrial cart 104 such that the photo-eye type sensor may view the location markers 224 positioned along the track 102 below the industrial cart 104. As such, the cart computing device 228 and/or master controller 106 may receive one or more signals generated from the photo-eye in response to detecting a location marker 224 as the industrial cart travels along the track 102. The cart computing device 228 and/or master controller 106, from the one or more signals, may determine the speed of the industrial cart 104. The speed information may be transmitted to the master controller 106 via the network 350 over network interface hardware 634 (FIG. 8).

FIG. 3B depicts a partial view of the assembly line grow pod 100 shown in FIG. 1, according to embodiments described herein. As illustrated, the industrial cart 204b is depicted as being similarly configured as the industrial cart 104 from FIG. 3A. However, in the embodiment of FIG. 3B, the industrial cart 204b is disposed on a track 102. As discussed above, at least a portion of the one or more wheels 222a, 222b, 222c, and 222d (or other portion of the industrial cart 204b) may couple with the track 102 to receive communication signals and/or power.

Also depicted in FIG. 3B are a leading cart 204a and a trailing cart 204c. As the industrial carts 204a, 204b, and 204c are moving along the track 102, the leading sensor 232b and the trailing sensor 234b may detect the trailing cart 204c and the leading cart 204a, respectively, and maintain a predetermined distance from the trailing cart 204c and the leading cart 204a.

As shown in FIG. 1, the airflow line 112 extends a plurality of floors of the assembly line grow pod 100 and, in some embodiments, all floors. The airflow line 112 may include a plurality of vents 304 each of which is configured to output airflow on each story of the assembly line grow pod 100. FIG. 3B depicts a partial view of the airflow line 112 including a vent 304. The vent 304 shown in FIG. 3B is configured to output air as indicated by arrows. The airflow line 112 is connected to the HVAC system 310 which controls the output of the airflow from the vent 304. The assembly line grow pod 100 and a HVAC system 310 are placed inside the external shell 200 of FIG. 2. The HVAC system 310 operates inside the external shell 200 and may be configured to control temperature, humidity, molecules, flow of the air inside the external shell 200.

The temperature sensors 236a, 236b, and 236c may detect temperature on each of the industrial carts 204a, 204b, and 204c, and transmit temperature information to the master controller 106. The master controller 106 controls the operation of the HVAC system 310 to control temperature of the air output from the vent 304 based on the temperature information received from the temperature sensors 236a, 236b, and 236c. In embodiments, the master controller 106 may identify payload 230 on the carts 204a, 204b, and 204c, and control the operation of the HVAC system 310 based on temperature recipes for the identified payload.

Still referring to FIG. 3B, one or more imaging devices 250 may be placed at the bottom of the track 102. The one or more imaging devices 250 may be placed throughout the track 102 including the ascending portion 102a, the descending portion 102b, and the connection portion 102c. The one or more imaging devices 250 may be any device having an array of sensing components (e.g., pixels) capable of detecting radiation in an ultraviolet wavelength band, a visible light wavelength band, or an infrared wavelength band. The one or more imaging devices 250 may have any resolution. The one or more imaging devices 250 are communicatively coupled to the master controller 106. For example, the one or more imaging devices 250 may be hardwired to the master controller 106 and/or may wirelessly communicate with the master controller 106. The one or more imaging devices 250 may capture an image of the payload 230 and transmit the captured image to the master controller 106. The master controller 106 may analyze the captured image to identify the payload 230. The master controller 106 may also identify the size and color of the payload 230 by analyzing the captured image.

FIG. 3C depicts air flow control system, according to one or more embodiments shown and described herein. The assembly line grow pod 100 and a HVAC system 310 are placed inside the external shell 200 of FIG. 2. The HVAC system 310 operates inside the external shell 200 and may be configured to control temperature, humidity, molecules, flow of the air inside the external shell 200. The dimensions of the air inside the external shell 200 may be less than, 10,000 cubic feet, for example, about 4,000 cubic feet. The HVAC system 310 may be optimized for the dimension of the air inside the external shell 200.

As illustrated in FIG. 3C, the assembly line grow pod 100 may include the master controller 106, which may include the computing device 130. The computing device 130 may include a memory component 540, which stores systems logic 544a and plant logic 544b. As described in more detail below, the systems logic 544a may monitor and control operations of one or more of the components of the assembly line grow pod 100. For example, the systems logic 544a may monitor and control operations of the HVAC system 310. The plant logic 544b may be configured to determine and/or receive a recipe for plant growth and may facilitate implementation of the recipe via the systems logic 544a. For example, the recipe may include temperature recipes for plants, and the systems logic 544a operates the HVAC system 310 based on the temperature recipes.

The assembly line grow pod 100 monitors the growth of plants carried in the carts 104, and the recipe for plant growth may be updated based on the growth of plants. For example, the temperature recipes for plants may be updated by monitoring the growth of those plants carried in the carts 104.

Additionally, the assembly line grow pod 100 is coupled to a network 350. The network 350 may include the internet or other wide area network, a local network, such as a local area network, a near field network, such as Bluetooth or a near field communication (NFC) network. The network 350 is also coupled to a user computing device 552 and/or a remote computing device 554. The user computing device 552 may include a personal computer, laptop, mobile device, tablet, server, etc. and may be utilized as an interface with a user. As an example, a user may send a recipe to the computing device 130 for implementation by the assembly line grow pod 100. Another example may include the assembly line grow pod 100 sending notifications to a user of the user computing device 552.

Similarly, the remote computing device 554 may include a server, personal computer, tablet, mobile device, etc. and may be utilized for machine to machine communications. As an example, if the assembly line grow pod 100 determines a type of seed being used (and/or other information, such as ambient conditions), the computing device 130 may communicate with the remote computing device 554 to retrieve a previously stored recipe for those conditions. As such, some embodiments may utilize an application program interface (API) to facilitate this or other computer-to-computer communications.

The HVAC system 310 may be connected to a plurality of airflow lines 112. Each of the air flow lines may include a plurality of vents 304. Each of the plurality of vents 304 is configured to output cooled or heated air. In embodiments, the plurality of vents 304 may correspond to the carts 104 on each floor of the assembly line grow pod 100. In some embodiments, the plurality of vents 304 may be placed at different locations. For example, the plurality of vents 304 may be placed at the top of the assembly line grow pod 100. As another example, the plurality of vents 304 may be placed at the bottom of the assembly line grow pod 100, and output air through a central axis of the ascending portion 102a or the descending portion 102b.

The HVAC system 310 may output cooled or heated air through the plurality of vents 304 according to a temperature recipe for plants. A temperature inside the external shell 200 may be detected by one or more temperature sensors 362. The one or more temperature sensors 362 may be positioned proximate to the track 102, carts 104, or at any other locations within the external shell 200. The one or more temperature sensors 362 may be wired to or wirelessly coupled to the master controller 106. For example, the one or more temperature sensors 362 may wirelessly transmit the detected temperature to the master controller 106 via the network 350. The master controller 106 compares the current temperature of the air inside the external shell 200 with the temperature recipe. For example, if the current temperature of air inside the external shell 200 is 84 Fahrenheit degrees, and the temperature recipe for the plants is 86 Fahrenheit degrees, the master controller 106 instructs the HVAC system 310 to output heated air until the air inside the external shell 200 become 86 Fahrenheit degrees.

The temperature recipes for plants may be stored in the plant logic 544b of the memory component 540 (and/or in the plant data 638b from FIG. 8) and the master controller 106 may retrieve the temperature recipes from the plant logic 544b. For example, the plant logic 544b may include temperature recipes for plants as shown in Table 1 below.

TABLE 1

| | Target Temperature |
|---|---|
| Plant A | 84 Fahrenheit degrees |
| Plant B | 80 Fahrenheit degrees |
| Plant C | 75 Fahrenheit degrees |
| Plant D | 71 Fahrenheit degrees |
| Plant E | 88 Fahrenheit degrees |

The master controller 106 may identify plants in the carts 104. For example, the master controller 106 may communicate with the carts 104 and receive information about the plants in the carts 104. As another example, the information about the plants in the carts 104 may be pre-stored in the master controller 106 when the seeder component 108 seeds plant A in the carts 104. As another example, the master controller 106 may receive images of the plants in the carts 104 captured by the one or more imaging devices 250 and identify the plants in the carts based on the captured images.

The master controller 106 may control the HVAC system 310 based on the identified plants. In one example, the current plants in the assembly line grow pod 100 are identified as plant B, the current temperature of the air inside the external shell 200 is 75 Fahrenheit degrees. Then, the master controller 106 controls the HVAC system 310 to output heated air such that the air inside the external shell 200 is maintained at 80 Fahrenheit degrees. In embodiments, the temperature recipes for plants may be updated based on information on harvested plants, for example, size and color of the harvested plants.

In some embodiments, the master controller 106 may receive a preferred temperature from the user computing device 552. For example, an operator inputs a temperature for plants currently growing in the assembly line grow pod 100. The master controller 106 receives the temperature and operates the HVAC system 310 based on the received temperature.

In embodiments, the master controller 106 may receive image of plants carried in the carts 104 from one or more imaging devices 380. One or more imaging devices 380 may be placed at the bottom of the track 102, e.g., the imaging devices 250 shown in FIG. 3B. The one or more imaging device 380 may be placed throughout the track 102 including the ascending portion 102a, the descending portion 102b, and the connection portion 102c. The one or more imaging devices 380 may be any device having an array of sensing components (e.g., pixels) capable of detecting radiation in an ultraviolet wavelength band, a visible light wavelength band, or an infrared wavelength band. The one or more imaging devices 380 are communicatively coupled to the master controller 106. For example, the one or more imaging devices 380 may be hardwired to the master controller 106 and/or may wirelessly communicate with the master controller 106. The one or more imaging devices 380 may capture an image of the plants carried in the carts 104 and transmit the captured image to the master controller 106.

In some embodiments, the assembly line grow pod 100 may include an infrared lens and/or other sensor to measure the temperature of the plant, cart, water, etc. The master controller 106 may receive the temperature of physical structure, e.g., the plants, carts, water, and compare ambient air with the temperature of the physical structure. The master controller 106 may determine how long it will take for the plant to reach an undesirable temperature (e.g., too high temperature, or too low temperature). The timing information and/or the temperature of the plant may be used to determine whether to expel heat generated inside the assembly line grow pod 100 to the outside of the external shell 200 or recycle the heat generated inside the assembly line grow pod 100. Additionally, the timing information and/or the temperature of the plant may be used to detect an HVAC or air passageway malfunction, determine the time it will take for the plant to be overheated or under-heated and determine how urgent it is to fix the malfunction of the HVAC system.

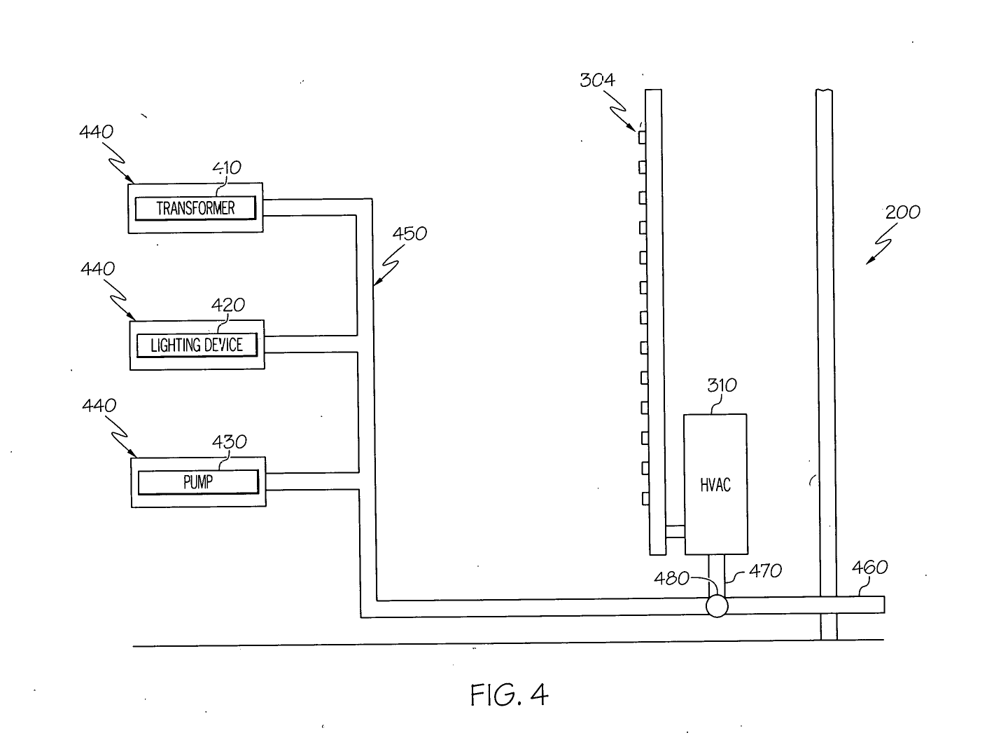

FIG. 4 depicts a device for recycling heat from heat generating devices, according to one or more embodiments shown and described herein. Inside the external shell 200, various devices generate heat while operating for the assembly line grow pod 100. For example, a transformer 410 for lighting devices, i.e., LEDs, generates heat when converting among different voltages, e.g., 5 V, 12 V, 24 V, etc. to operate the lighting devices. The transformer 410 may generate most of the heat among the heat generating devices of the assembly line grow pod 100. A heat insulating layer 440 insulates heat generated by the transformer 410 and transfers heat to a heat passageway 450. The heat passageway 450 may be an insulating passageway retaining heat within the passageway. The heat insulating layer 440 may be made of any heat insulating materials, e.g., fiberglass, mineral wool, cellulose, polyurethane foam, polystyrene, etc. The heat passageway 450 is connected to a heat transfer device 480, and insulates heat inside the heat passageway 450 from outside. The heat passageway 450 transfers heated air from the transformer 410 to the heat transfer device 480. The heat transfer device 480 is connected to the HVAC system 310 via a heat passageway 470 and is connected to a heat passage way 460 which is extended to outside the external shell 200.

The heat transfer device 480 may be configured to transfer heat to either the HVAC system 310 through the heat passageway 470 or outside through the heat passageway 460. The heat transfer device 480 may include one or more valves that allow heat generated from the transformer 410 to be transferred to the heat passageway 470 or to the heat passageway 460. For example, the heat transfer device 480 may close an entrance to the heat passageway 470 such that the heat may be transferred to the heat passageway 460, or close an entrance to the heat passageway 460 such that the heat may be transferred to the heat passageway 470. In some embodiments, the heat transfer device 480 may include one or more fans that flow air in a certain direction.

Similar to the transformer 410, other heat generating devices are covered by the heat insulating layer 440. For example, as shown in FIG. 4, lighting devices 420 and a pump 430 for the assembly line grow pod 100 may be covered by the heat insulating layers 440 to insulate heat generated by the lighting devices 420 and the pump 430. The lighting devices 420 generate heat when the lighting devices 420 output lights to plants, and the pump 430 generates heat when pumping water. Each of the heat insulating layers 440 are connected to the heat transfer device 480 via the heat passageway 450 such that the heat generated by the lighting devices 420 or the pump 430 may be transferred to the heat transfer device 480.

When the heat transfer device 480 transfers heat to the HVAC system 310, the HVAC system 310 may recycle the heat received from the heat generating devices, and provide the recycled heat to the area inside the external shell 200 through the plurality of vents 304. Particularly, the HVAC system 310 provides the recycled heat to where heat is needed, for example, plants on the carts 104. The master controller 106 may determine whether to recycle heat or not and provide recycled heat to the inside of the external shell 200 based on the current temperature inside the external shell 200 and temperature required for plants currently being cultivated. For example, if the current temperature is 80 Fahrenheit and the temperature required for plants currently being cultivated is 85 Fahrenheit, the master controller 106 may instruct the HVAC system 310 to fully recycle the heat generated from the heat generating devices.

The heat passageway 460 outputs heat to the outside of the external shell 200 or receives cooled air from the outside of the external shell 200. One end of the heat passageway 460 may be coupled to the heat transfer device 480, and the other end of the heat passageway 460 is exposed to the outside of the external shell 200. The heat transfer device 480 may expel heat generated inside the external shell 200 to the outside of the external shell 200 through the heat passageway 460. For example, if the current temperature within the external shell 200 is 89 Fahrenheit and the temperature required for plants currently being cultivated is 85 Fahrenheit, the master controller 106 instructs the heat transfer device 480 to transfer the heat received from one or more of the transformer 410, the lighting devices 420, and the pump 430 to the outside of the external shell 200 via the heat passageway 460 in order to prevent the air inside the external shell 200 from being overheated. In some embodiments, the heat passageway 450 may be directed to certain locations of the operational structure of the assembly line grow pod 100 and provide heated air to the locations without being routed to the HVAC system 310.

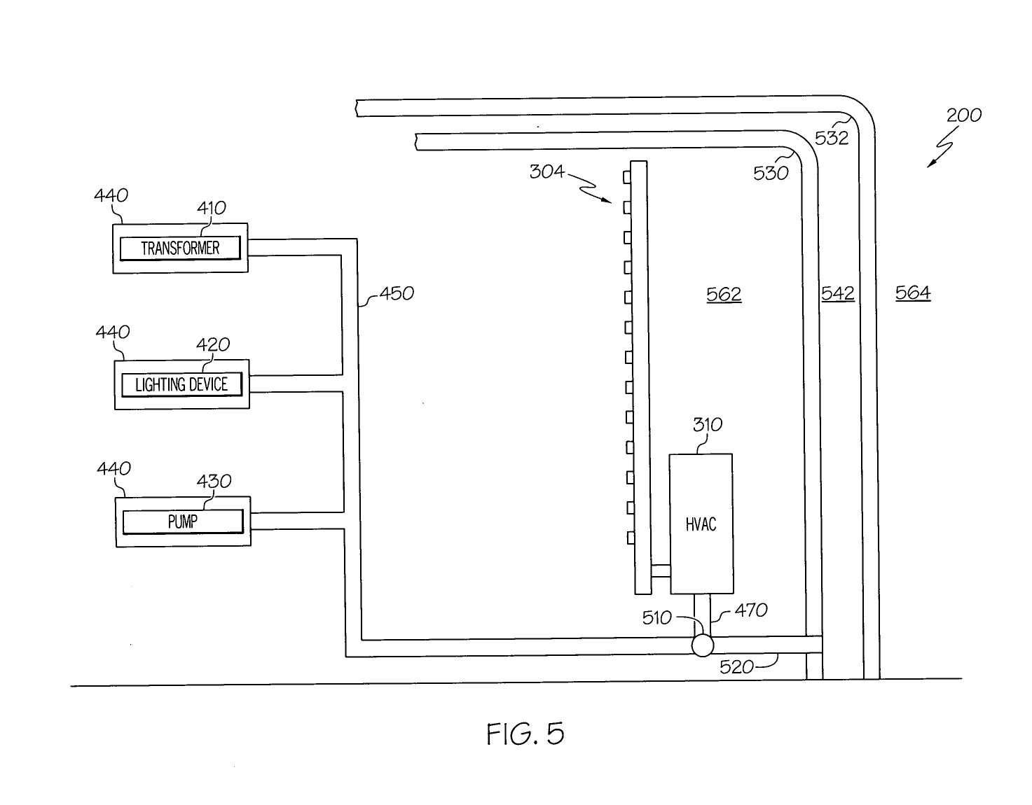

FIG. 5 depicts recycling heat from heat generating devices, according to another embodiment shown and described herein. As described with respect to FIG. 4, various devices including the transformer 410, lighting devices 420, and the pump 430 generate heat while operating for the assembly line grow pod 100. The assembly line grow pod 100 is enclosed by the external shell 200. The external shell 200 may include an outer wall 532 and an inner wall 530. Heat insulating layers 440 insulate heat generated by the transformer 410, the lighting devices 420, and the pump 430 and transfer the heat to a heat passageway 450. The heat passageway 450 may be an insulating passageway retaining heat within the passageway. The heat insulating layer 440 may be made of any heat insulating materials, e.g., fiberglass, mineral wool, cellulose, polyurethane foam, polystyrene, etc. The heat passageway 450 is connected to a heat transfer device 510, and insulates heat inside the heat passageway 450 from outside. The heat passageway 450 transfers heated air generated from the transformer 410, the lighting devices 420, and the pump 430 to the heat transfer device 510. The heat transfer device 510 is connected to the HVAC system 310 via a heat passageway 470 and is connected to a heat passage way 520 which is extended to an area 542 between the inner wall 530 and the outer wall 532 of the external shell 200.

The heat transfer device 510 may be configured to transfer heated air to either the HVAC system 310 through the heat passageway 470 or the area 542 through the heat passageway 520. The heat transfer device 510 may include one or more valves that allow heated air generated from the transformer 410, the lighting devices 420, and pump 430 to be transferred to the heat passageway 470 or to the heat passageway 520. For example, the heat transfer device 510 may close an entrance to the heat passageway 470 such that the heated air may be transferred to the heat passageway 520, or close an entrance to the heat passageway 520 such that the heated air may be transferred to the heat passageway 470.

When the heat transfer device 510 transfers heated air to the HVAC system 310, the HVAC system 310 may recycle the heat received from the heat generating devices, and provide the recycled heat to the area inside the external shell 200 through the plurality of vents 304. Particularly, the HVAC system 310 provides the recycled heat to where heat is needed, for example, plants on the carts 104. The master controller 106 may determine whether to recycle heat and provide recycled heat to the inside of the external shell 200 based on the current temperature inside the external shell 200 and temperature required for plants currently being cultivated. For example, if the current temperature is 80 Fahrenheit and the temperature required for plants currently being cultivated is 85 Fahrenheit, the master controller 106 may instruct the HVAC system 310 to fully recycle the heated air generated from the heat generating devices.

One end of the heat passageway 520 may be coupled to the heat transfer device 510, and the other end of the heat passageway 520 is exposed to the area 542 between the inner wall 530 and the outer wall 532. The heat passageway 520 outputs heated air to the area 542 such that the pressure within the area 542 is greater than the pressure within an area 562 or the pressure in the outside area 564. The positive pressure created in the area 542 prevents external contaminants from entering into the area 562 within the external shell 200.

The heat transfer device 510 may expel heated air generated inside the external shell 200 to the area 542 through the heat passageway 520. For example, if the current temperature within the external shell 200 is 89 Fahrenheit and the temperature required for plants currently being cultivated is 85 Fahrenheit, the master controller 106 instructs the heat transfer device 510 to transfer the heated air received from one or more of the transformer 410, the lighting devices 420, and the pump 430 to the area 542 via the heat passageway 520 such that the air inside the external shell 200 is prevented from being overheated and positive pressure is generated within the area 542 as opposed to the area 562 and the outside 564.

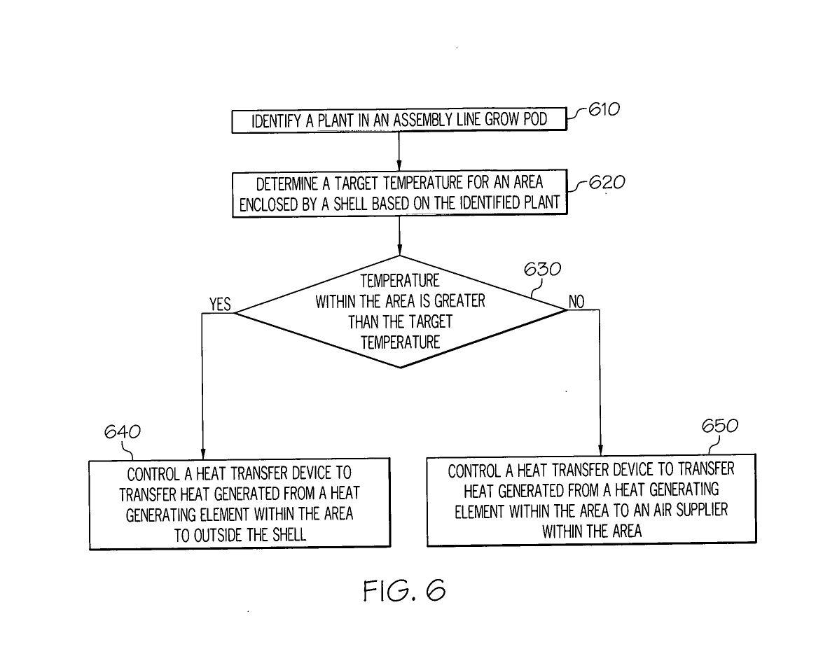

FIG. 6 depicts a flowchart for recycling heat in an assembly line grow pod, according to embodiments shown and described herein. In block 610, the master controller 106 identifies a plant in an assembly line grow pod. For example, an operator inputs the type of seeds for plants that need to be grown in the carts through the user computing device 552, and the master controller 106 receives the type of seeds for plants from the user computing device 552. As another example, the master controller 106 may obtain identification of plants from the seeder component 108 that seeds the plants in the carts. As another example, the master controller 106 may receive images of plants captured by the one or more imaging devices 250 and process the images to identify the plants.

In block 620, the master controller 106 determines a target temperature for an area enclosed by the external shell 200 based on the identified plant. For example, if the identified plant is plant A, the master controller 106 may determine that the target temperature for an area enclosed by the external shell 200 is 84 Fahrenheit degrees based on the temperature recipe shown in Table 1 above.

In block 630, the master controller 106 determines whether the temperature in the area enclosed by the external shell 200 is greater than the target temperature. The master controller 106 may receive the temperature in the area enclosed by the external shell 200 from one or more temperature sensors 362 in the assembly line grow pod 100. For example, the master controller 106 may receive temperature information from the temperature sensors 236 in the carts 104 (FIG. 3B). If it is determined that the temperature within the area is greater than the target temperature, the master controller 106 may control the heat transfer device 480 to transfer heated air generated from heat generating devices to the outside of the external shell 200 in block 640. For example, if the temperature within the area is 87 Fahrenheit degrees and the target temperature is 84 Fahrenheit degrees, the master controller 106 may control the heat transfer device 480 to expel the heated air outside the external shell 200 through the heat passageway 460 in FIG. 4.

If it is determined that the temperature within the area is not greater than the target temperature, the master controller 106 may control the heat transfer device 480 to transfer heated air generated from heat generating devices to an air supplier within the area (e.g., the HVAC system 310 in FIG. 3C). For example, if the temperature within the area is 80 Fahrenheit degrees and the target temperature is 84 Fahrenheit degrees, the master controller 106 may control the heat transfer device 480 to transfer the heated air to the HVAC system 310 through the heat passageway 470 such that the HVAC system 310 can recycle the heat generated from the heat generating devices.

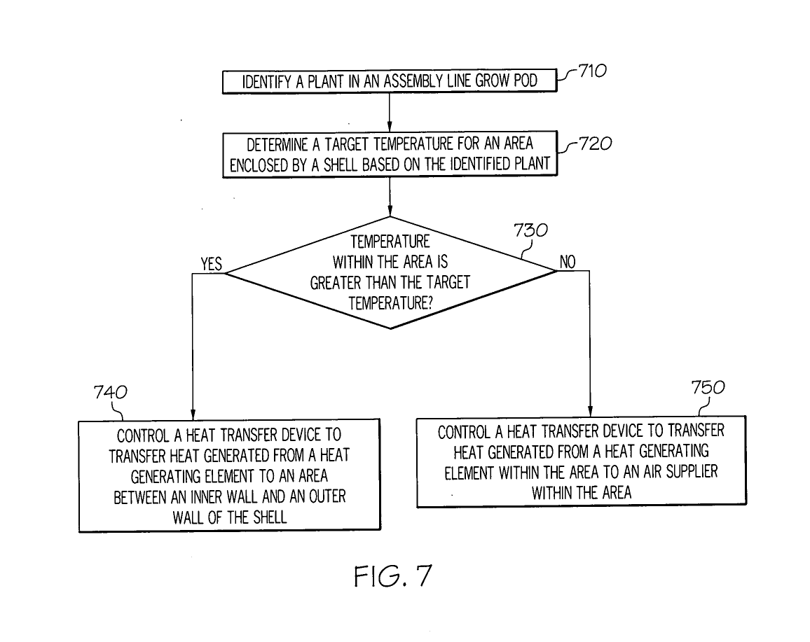

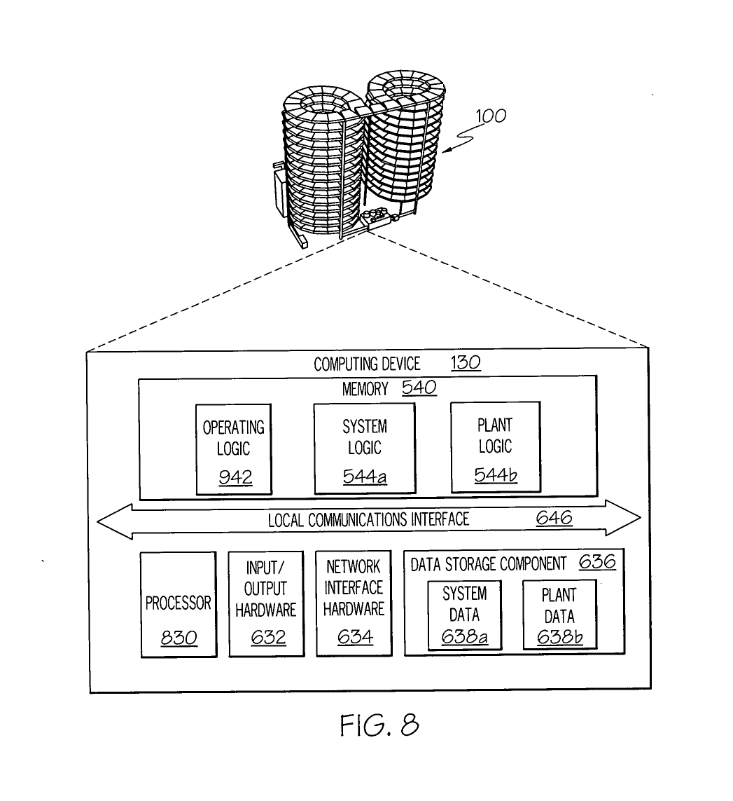

FIG. 7 depicts a flowchart for recycling heat in an assembly line grow pod, according to another embodiment shown and described herein. In block 710, the master controller 106 identifies a plant in an assembly line grow pod. For example, an operator inputs the type of seeds for plants that need to be grown in the carts through the user computing device 552, and the master controller 106 receives the type of seeds for plants from the user computing device 552. As another example, the master controller 106 may obtain identification of plants from the seeder component 108 that seeds the plants in the carts. As another example, the master controller 106 may receive images of plants captured by the one or more imaging devices 250 and process the images to identify the plants.

In block 720, the master controller 106 determines a target temperature for an area enclosed by the external shell 200 based on the identified plant. For example, if the identified plant is plant A, the master controller 106 may determine the target temperature for an area enclosed by the external shell 200 is 84 Fahrenheit degrees based on the temperature recipe shown in Table 1 above.

In block 730, the master controller 106 determines whether the temperature in the area enclosed by the external shell 200 is greater than the target temperature. The master controller 106 may receive the temperature in the area enclosed by the external shell 200 from one or more temperature sensors 362 in the assembly line grow pod 100. If it is determined that the temperature within the area is greater than the target temperature, the master controller 106 may control the heat transfer device 480 to transfer heated air generated from heat generating devices to the area 542 between the inner wall 530 and the outer wall 532. For example, if the temperature within the area is 87 Fahrenheit degrees and the target temperature is 84 Fahrenheit degrees, the master controller 106 may control the heat transfer device 480 to expel heated air, via the heat passageway 520, into the area 542 between the inner wall 530 and the outer wall 532 such that positive pressure is maintained in the area 542 against the area 562 and the outside 564.

If it is determined that the temperature within the area is not greater than the target temperature, the master controller 106 may control the heat transfer device 480 to transfer heat generated from heat generating devices to an air supplier within the area (e.g., the HVAC system 310 in FIG. 3C). For example, if the temperature within the area is 80 Fahrenheit degrees and the target temperature is 84 Fahrenheit degrees, the master controller 106 may control the heat transfer device 480 to transfer the heated air to the HVAC system 310 through the heat passageway 470 such that the HVAC system 310 can recycle the heat generated from the heat generating devices.

FIG. 8 depicts a computing device 130 for an assembly line grow pod 100, according to embodiments described herein. As illustrated, the computing device 130 includes a processor 830, input/output hardware 632, the network interface hardware 634, a data storage component 636 (which stores systems data 638a, plant data 638b, and/or other data), and the memory component 540. The memory component 540 may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), and/or other types of non-transitory computer-readable mediums. Depending on the particular embodiment, these non-transitory computer-readable mediums may reside within the computing device 130 and/or external to the computing device 130.

The memory component 540 may store operating logic 642, the systems logic 544a, and the plant logic 544b. The systems logic 544a and the plant logic 544b may each include a plurality of different pieces of logic, each of which may be embodied as a computer program, firmware, and/or hardware, as an example. A local interface 646 is also included in FIG. 7 and may be implemented as a bus or other communication interface to facilitate communication among the components of the computing device 130.

The processor 830 may include any processing component operable to receive and execute instructions (such as from a data storage component 636 and/or the memory component 540). The input/output hardware 632 may include and/or be configured to interface with microphones, speakers, a display, and/or other hardware.

The network interface hardware 634 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the computing device 130 and other computing devices, such as the user computing device 552 and/or remote computing device 554.

The operating logic 642 may include an operating system and/or other software for managing components of the computing device 130. As also discussed above, systems logic 544a and the plant logic 544b may reside in the memory component 540 and may be configured to performer the functionality, as described herein.

It should be understood that while the components in FIG. 8 are illustrated as residing within the computing device 130, this is merely an example. In some embodiments, one or more of the components may reside external to the computing device 130. It should also be understood that, while the computing device 130 is illustrated as a single device, this is also merely an example. In some embodiments, the systems logic 544a and the plant logic 544b may reside on different computing devices. As an example, one or more of the functionalities and/or components described herein may be provided by the user computing device 552 and/or remote computing device 554.

Additionally, while the computing device 130 is illustrated with the systems logic 544a and the plant logic 544b as separate logical components, this is also an example. In some embodiments, a single piece of logic (and/or or several linked modules) may cause the computing device 130 to provide the described functionality.

As illustrated above, various embodiments for recycling heat in a grow pod are provided. These embodiments create a quick growing, small footprint, chemical free, low labor solution to growing microgreens and other plants for harvesting. These embodiments may create recipes and/or receive recipes that dictate temperature and humidity which optimize plant growth and output. The recipe may be implemented strictly and/or modified based on results of a particular plant, tray, or crop.

Accordingly, some embodiments may include a heat recycling system. The system includes a shell including an enclosed area, an air supplier within the enclosed area, one or more vents connected to the air supplier and configured to output air within the enclosed area, a heat generating device within the enclosed area, a heat insulating element configured to cover the heat generating device and transfer heated air by the heat generating device to a heat passageway, a heat transfer device connected to the heat passageway, and a controller. The controller determines a target temperature for the enclosed area; determines whether a temperature within the enclosed area is greater than the target temperature; and controls the heat transfer device to transfer the heated air to an outside of the shell in response to determination that the temperature within the enclosed area is greater than the target temperature.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein.

What is claimed is:

1. A heat recycling system comprising:
a shell defining an enclosed area;
an air supplier within the enclosed area;
one or more vents connected to the air supplier and configured to output air within the enclosed area;
a heat generating device within the enclosed area;
a heat insulating element configured to cover the heat generating device and connected to a heat passageway;
a heat transfer device connected to the heat passageway; and
a controller comprising:
one or more processors;
one or more memory modules; and
machine readable instructions stored in the one or more memory modules that, when executed by the one or more processors, cause the controller to:
determine a target temperature for the enclosed area;
determine whether a temperature within the enclosed area is greater than the target temperature; and
control the heat transfer device to transfer air heated by the heat generating device to an outside of the shell in response to determination that the temperature within the enclosed area is greater than the target temperature.

2. The heat recycling system of claim 1, further comprising one or more lighting devices in the enclosed area,
wherein the heat generating device includes a transformer electrically connected to the one or more lighting devices.

3. The heat recycling system of claim 1, wherein the heat generating device includes a lighting device.

4. The heat recycling system of claim 1, wherein the heat generating device includes a pumping device.

5. The heat recycling system of claim 1, wherein the machine readable instructions stored in the one or more memory modules, when executed by the one or more processors, cause the controller to control the heat transfer device to transfer the air heated by the heat generating device to the air supplier in response to determination that the temperature within the enclosed area is less than the target temperature.

6. The heat recycling system of claim 5, wherein the air supplier provides the air heated by the heat generating device into the enclosed area.

7. The heat recycling system of claim 1, wherein the machine readable instructions stored in the one or more memory modules, when executed by the one or more processors, cause the controller to:
identify a plant in the enclosed area;
retrieve a temperature recipe for the identified plant; and
determine the target temperature based on the temperature recipe.

8. The heat recycling system of claim 1, wherein the heat transfer device includes a valve configured to change a flow direction of the air heated by the heat generating device.

9. A method for recycling heat in an assembly line grow pod, the method comprising:
determining, by a controller of the assembly line grow pod, a target temperature for an area enclosed by a shell;
determining, by the controller of the assembly line grow pod, whether a temperature within the area is greater than the target temperature; and
controlling, by the controller of the assembly line grow pod, a heat transfer device to transfer air heated by a heat generating device within the area to an outside of the shell in response to determination that the temperature within the area is greater than the target temperature.

10. The method of claim 9, wherein the heat generating device includes a transformer electrically connected to one or more lighting devices positioned in the area enclosed by the shell.

11. The method of claim 9, wherein the heat generating device includes a lighting device.

12. The method of claim 9, wherein the heat generating device includes a pumping device.

13. The method of claim 9, further comprising controlling, by the controller of the assembly line grow pod, a heat transfer device to transfer the air heated by the heat generating device to an air supplier positioned within the area in response to determination that the temperature within the area is less than the target temperature.

14. The method of claim 9, further comprising:
identifying a plant in the area enclosed by the shell;
retrieving a temperature recipe for the identified plant; and
determining the target temperature based on the temperature recipe.

15. The method of claim 9, wherein the heat transfer device includes a valve configured to change a flow direction of the air heated by the heat generating device.

16. A heat recycling system comprising:
a shell including an enclosed area, the shell including an outer wall and an inner wall;
an air supplier within the enclosed area;
one or more vents connected to the air supplier and configured to output air within the enclosed area;
a heat generating device within the enclosed area;
a heat insulating element configured to cover the heat generating device and connected to a heat passageway;
a heat transfer device connected to the heat passageway; and
a controller comprising:
one or more processors;
one or more memory modules; and
machine readable instructions stored in the one or more memory modules that, when executed by the one or more processors, cause the controller to:
determine a target temperature within the enclosed area;
determine whether a temperature within the enclosed area is greater than the target temperature; and
control the heat transfer device to transfer the air heated by the heat generating device to an area between the inner wall and the outer wall in response to determination that the temperature within the enclosed area is greater than the target temperature.

17. The heat recycling system of claim 16, further comprising one or more lighting devices in the enclosed area,
wherein the heat generating device includes a transformer electrically connected to the one or more lighting devices.

18. The heat recycling system of claim 16, wherein the machine readable instructions stored in the one or more memory modules, when executed by the one or more processors, cause the controller to control the heat transfer device to transfer the air heated by the heat generating device to the air supplier in response to determination that the temperature within the enclosed area is less than the target temperature.

19. The heat recycling system of claim 16, wherein the machine readable instructions stored in the one or more memory modules, when executed by the one or more processors, cause the controller to:
identify a plant in the enclosed area;
retrieve a temperature recipe for the identified plant; and
determine the target temperature based on the temperature recipe.

20. The heat recycling system of claim 16, wherein the heat transfer device includes a valve configured to change a flow direction of the air heated by the heat generating device.
